(19) United States
(12) Patent Application Publication
(10) Pub. No.: US 2025/0308305 A1
(43) Pub. Date: Oct. 2, 2025

(54) ELECTRONIC DOOR SYSTEM WITH VOICE PASSTHROUGH

(71) Applicant: Master Lock Company LLC, Oak Creek, WI (US)

(72) Inventors: Mark Caterino, Prospect, CT (US); Aaron Treger, Pinole, CA (US)

(73) Assignee: Master Lock Company LLC, Oak Creek, WI (US)

(21) Appl. No.: 19/094,475

(22) Filed: Mar. 28, 2025

Related U.S. Application Data
(60) Provisional application No. 63/572,149, filed on Mar. 29, 2024.

(51) Int. Cl. G07C 9/00

(52) U.S. Cl. CPC G07C 9/00563

(57) ABSTRACT

A door system includes a controller. The controller is configured to receive an indication of a trigger event associated with a door, initiate a collection of data via an audio device, provide a prompt for a user to provide an audio input, terminate the collection of data based on criteria associated with the audio input or the trigger event, and transmit the data to an external device for processing by the external device.

### CROSS-REFERENCE TO RELATED PATENT APPLICATIONS

This application claims the benefit of and priority to U.S. Provisional Patent Application No. 63/572,149, filed on Mar. 29, 2024, the entirety of which is incorporated by reference herein.

### BACKGROUND

The present disclosure relates generally to systems for monitoring and controlling entry into a structure. More specifically, the present disclosure relates to a system for electronically controlling a door.

### SUMMARY

At least one embodiment relates to a door system. The door system integrates with or couples to a door. The door system can include a controller. The controller is configured to communicate with a motor to control a lock for the door. The controller is configured to receive an indication of a trigger event associated with the door; initiate, responsive to receipt of the indication of the trigger event, a collection of data via an audio device; provide, via the audio device, responsive to initiation of the collection of the audio input, a prompt for a user to provide an audio input; terminate the collection of data based on criteria associated with the audio input or the trigger event; and transmit the data to an external device for processing by the external device.

Another embodiment relates to a door lock system. The door lock system includes a lock including a motor where the lock is configured to couple to a door and a controller in communication with the motor to control the lock. The controller is configured to receive an indication of a trigger event associated with the door, initiate control of a microphone to collect an audio input, and transmit the audio input to an external device for processing by the external device.

Another embodiment relates to a system. The system includes one or more memory devices. The one or more memory device can store instructions thereon. The instructions cause, when executed by one or more processors, the one or more processors to provide, to a controller via one or more signals, responsive to detection of a trigger event associated with a door, an indication of the trigger event. The instructions also cause the one or more processors to receive, from the controller via one or more second signals, data collected by the controller as a result of the trigger event. The instructions also cause the one or more processors to retrieve, from a database, information associated with the door. The instructions also cause the one or more processors to evaluate, responsive to retrieval of the information, the data collected by the controller based on the information associated with the door. The instructions also cause the one or more processors to detect, responsive to evaluation of the data, a match between at least a portion of the data collected by the controller and at least a portion of the information. The instructions can also cause the one or more processors to transmit, responsive to detection of the match, one or more third signals, to the controller, to provide an indication of to unlock the door.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a front view showing an exterior side of a door system, according to an exemplary embodiment.

FIG. 2 is a rear view showing an interior side of the door system of FIG. 1, according to an exemplary embodiment.

FIG. 3 is a block diagram of a control system of the door system of FIG. 1, according to an exemplary embodiment.

FIG. 4 is another block diagram of the control system illustrated in FIG. 3, according to an exemplary embodiment.

FIG. 5 is a flow chart of a process to collect data associated with one or more trigger events, according to an exemplary embodiment.

FIG. 6 is a flow chart of a process to evaluate data collected as a result of one or more trigger events, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, an electronic door system with voice passthrough is described herein. Voice passthrough may refer to and/or include a collection of data and/or datasets by a first device and an evaluation of the data (e.g., verification, authentication, analysis, etc.) by a second device. For example, audio data (e.g., spoken words, spoken numbers, spoken characters, etc.) may be collected by an audio device (e.g., a microphone, a recorder, and/or various other devices that may convert sound to electrical signals). To continue this example, the audio data may be transmitted and/or provided to a remote and/or external device (e.g., a third-party device, a server, a computing device, etc.) for processing.

Some technical solutions described herein include a reduction of an overall size of a controller given that voice passthrough provides for the controller to collect the audio data and not process the audio data (e.g., the controller can have fewer parts), multi-factor authentication as the audio data can be compared to information stored in a remote database, and additional security with respect to control of when to lock and/or unlock a door given that the audio data is processed remotely.

### Overall Door System

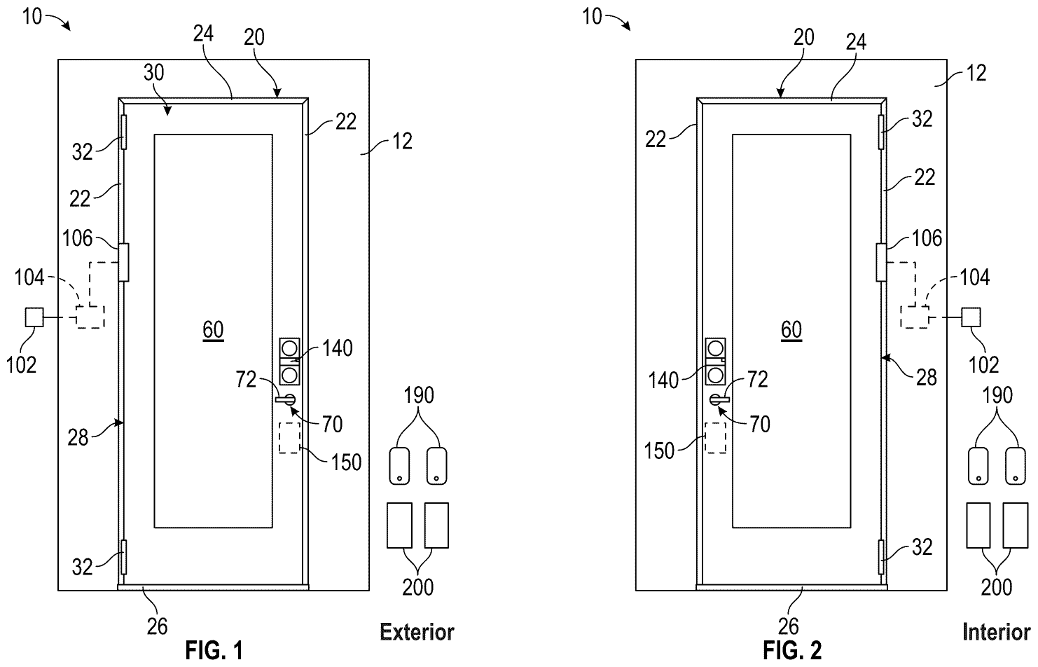

Referring to FIGS. 1 and 2, an electronic door system or electronic door assembly is shown as door system 10, according to an exemplary embodiment. The door system 10 may incorporate any structure, functionality, and/or features of the door system described in International Publication No. WO2024/006540, filed on Jun. 30, 2023, which is incorporated herein by reference in its entirety.

The door system 10 may facilitate selective access to a structure or building, such as a home, an apartment, a garage, or a commercial building, having one or more walls 12. While the door system 10 may be discussed herein as being used with a home, it should be understood that the door system 10 may alternatively be used with any other type of structure. By way of example, the door system 10 may prevent access to an interior of the structure by unauthorized users and permit access to the interior of the structure by authorized users (e.g., homeowners, residents, invited guests, etc.). The door system 10 may provide one or more electronic systems that facilitate control over access to the interior of the structure.

The door system 10 includes a stationary portion or door frame 20 coupled to or installed within the wall 12. The door frame 20 includes a series of frame sections, shown as side jambs 22, head jamb 24, and sill 26. The side jambs 22 extend substantially vertically and are laterally offset from one another. The head jamb 24 extends substantially horizontally between the top end portions of the side jambs 22. The sill 26 extends substantially horizontally between the bottom end portions of the side jambs 22. Together, the side jambs 22, the head jamb 24, and the sill 26 define a passage, aperture, or opening, shown as doorway 28 therebetween. The doorway 28 may be sized to facilitate the passage of one or more users through the doorway 28.

The door system 10 further includes a movable portion, body, door slab, or door leaf, shown as door 30. The door 30 is movably coupled to the door frame 20 by one or more hinges, shown as hinges 32. Specifically, the hinges 32 are each coupled to a side jamb 22 and to the door 30. As shown, the hinges 32 pivotally couple the door 30 to the door frame 20 such that the door is pivotable or rotatable about a substantially vertical axis. In other embodiments, the door 30 is otherwise movably coupled to the door frame 20 (e.g., slidably coupled).

The door 30 is selectively repositionable between (a) a blocking position, shut position, or closed position and (b) an unobstructed position or open position. In the closed position, the door 30 extends across the doorway 28, preventing movement of a user through the doorway 28. In the open position, the door 30 is moved out of the doorway 28, permitting movement of the user through the doorway 28. The door 30 may swing inward (e.g., into the structure) and/or outward (e.g., away from the structure). In some configurations, the door 30 is coupled to a first one of the side jambs 22. In other configurations, the door 30 is coupled to the other of the side jambs 22. In some embodiments, the door 30 can be coupled to either of the side jambs 22 according to a preference of the user. Accordingly, the door 30 can be configured as a right hand door or a left hand door.

In some embodiments, the door 30 is constructed using wood, such as engineered wood or hardwood. In some embodiments, the door 30 is constructed using another material, such as metal, plastic, or a composite material (e.g., fiberglass). The door 30 may be formed from a single material or a combination of materials. In some embodiments, the door 30 is formed from a subframe covered by one or more panels or skins. In other embodiments, the door 30 is formed from a single piece of material.

The door 30 further includes one or more panes of transparent material (e.g., glass, polycarbonate, etc.) or privacy windows, shown as window 60. As shown, the window 60 is positioned adjacent the center of the door 30, such that the window 60 is surrounded on the top, bottom, left, and right sides by the subframe 40. The window 60 provides a line of sight through the door 30. The window 60 may be held in place by (e.g., fixedly coupled to) the subframe 40, the exterior skin 50, and/or the interior skin 52. In some embodiments, the door 30 includes a single, uninterrupted window 60 (e.g., as shown in FIG. 1). In other embodiments, the door 30 includes multiple windows 60. In yet other embodiments, the window 60 is omitted.

Referring to FIGS. 1 and 2, the door 30 includes an interface assembly, lockset, or handle assembly, shown as handle assembly 70. The handle assembly 70 serves as an interface through with the user can control opening and closing of the door 30. The handle assembly 70 includes a pair of interfaces (e.g., handles, knobs, pulls, push plates, etc.), shown as handles 72, configured to interface with a hand of a user. Specifically, a first handle 72 is positioned on the exterior side of the door 30, and a second handle 72 is positioned on the interior side of the door. The user may apply a pushing or pulling force onto the handle 72 to move the door 30 toward the open position or the closed position, as desired.

In some embodiments, the handle assembly 70 includes a latch and/or secondary deadbolt that extends outward from the door 30 to be received within a corresponding pocket or pockets defined by the door frame 20 to hold the door 30 in the closed position and/or locked configuration. In some such embodiments, the latch may be retracted by moving (e.g., rotating) one or both of the handles 72 relative to the rest of the door 30 and/or the main deadbolt may be retracted by turning a deadbolt thumb turn. Once retracted, the door 30 may be moved out of the closed position (i.e., the door may be opened). In some embodiments, components of the handle assembly 70 operate mechanically and/or electromechanically (e.g., the handle assembly 70 includes an electromechanical locking mechanism such as an electronic main deadbolt). In some embodiments, the handle assembly 70 can be operated by either handle 72.

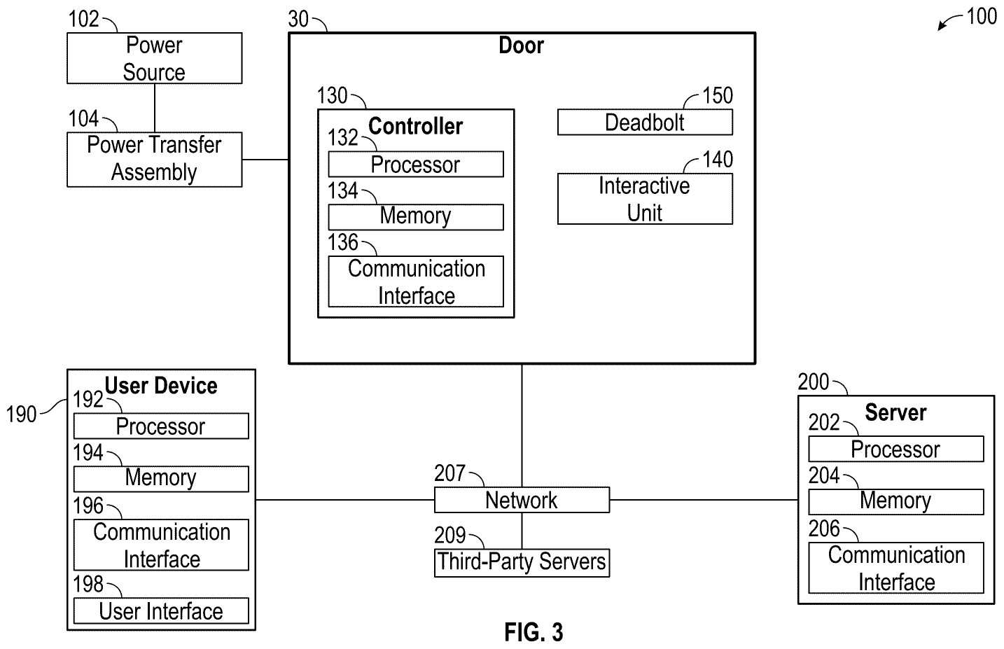

Referring to FIG. 3, the door system 10 includes an electronic control system or intelligent control system, shown as control system 100. The control system 100 may provide one or more features or functions that facilitate operation of the door system 10. The control system 100 may receive one or more inputs (e.g., sensor inputs, user commands, etc.) and provide one or more outputs (e.g., lights, sounds, movement of actuators, etc.).

Referring to FIGS. 1-4, the control system 100 may be at least partially powered by an external power source or external power supply, shown as power source 102. The power source 102 is configured to supply electrical energy to power operation of the door 30 and the electronic components thereof. By way of example, the power source 102 may supply electrical energy from a power grid (e.g., a municipal power grid), generators, solar panels, wind turbines, batteries, capacitors, fuel cells, or other sources. The power source 102 may be positioned inside and/or outside of the structure having the walls 12. The power source 102 may be electrically coupled to the control system 100 through at least one power transfer assembly 104 or power conditioners (e.g., transformers, alternating current (AC) to direct current (DC) rectifiers, DC to AC inverters, etc.). Electrical energy from the power source 102 may be transferred (e.g., through a wired connection or wirelessly) to the door 30 by a door power transfer assembly 106 (e.g., electrical contacts, a power transfer hinge, a cable, wireless charging pads, etc.). In other embodiments, the control system 100 is powered by an onboard energy source (e.g., one or more batteries or capacitors) that is coupled to the door 30. In some embodiments, the onboard energy source provides DC electrical energy.

As shown in FIG. 3, the door 30 includes a controller 130 that controls operation of the door 30. The controller 130 includes a processing circuit, shown as processor 132, operatively coupled to a memory device, shown as memory 134. The memory 134 may store one or more instructions that are executed by the processor 132 to perform the processes described herein. The controller 130 includes a network interface or communication adapter, shown as communication interface 136. The communication interface 136 is configured to facilitate communication between the door 30 and the other components of the control system 100 (e.g., through the network 207). The communication interface 136 may be configured to perform wired and/or wireless configuration. By way of example, the communication interface 136 may communicate using NFC, RFID, BLE, Bluetooth, Wi-Fi, Zigbee, radio, over a cellular network, or through another communication protocol. In some embodiments, the communication interface 136 communicates according to the Matter standard. In some embodiments, the communication interface 136 communicates with AirBNB, VRBO, etc. The communication interface 136 may communicate directly with other devices or over a local area network or a wide area network (e.g., the Internet).

As shown in FIGS. 1-4, the door 30 further includes a user interface, an operator interface, an interface module, or an interactive unit, shown as interactive unit 140. The interactive unit 140 may act as a user interface to provide information to a user or to receive information (e.g., commands) from a user. The interactive unit 140 may include one or more input devices (e.g., keypads, buttons, switches, knobs, pull cords, microphones, cameras, touch screens, etc.) that receive inputs from a user. The interactive unit 140 may include one or more output devices (e.g., speakers, displays, lights, buzzers, etc.) that provide information to a user.

The interactive unit 140 may be accessed from the interior side and/or the exterior side of the door 30. In embodiments where the interactive unit 140 is accessible from both the interior side and the exterior side of the door 30, the interactive unit 140 may permit utilizing different functions depending upon which side of the interactive unit 140 is being accessed. In some embodiments, the interactive unit 140 is in wired communication and/or wireless communication with the controller 130. The controller 130 may control operation of the interactive unit 140.

The door 30 further includes one or more lock assemblies, shown as deadbolt 150. The deadbolt 150 includes a lock member that selectively engages the door frame 20 to prevent movement of the door 30 out of the closed position (e.g., in addition to the main deadbolt of the handle assembly 70, etc.). The lock member may be manually actuated (e.g., by turning a knob) and/or electronically controlled (e.g., using an electric motor). The deadbolt 150 may be a main deadbolt of the handle assembly 70, or the deadbolt 150 may be supplemental to a deadbolt of the handle assembly 70. In some embodiments, the interactive unit 140 permits user control over the deadbolt 150. By way of example, in response to a user inputting a predetermined code into a keypad of the interactive unit 140, the controller 130 may control an electric motor of the deadbolt 150 to lock or unlock the deadbolt 150.

Referring to FIG. 3, the control system 100 may include one or more external devices that communicate with the door 30. The door 30 may communicate with the external devices directly or through a network 207 (e.g., a wired and/or wireless network, a local area network, a wide area network, a cellular network, etc.). In some embodiments, the control system 100 includes a network interface or access point (e.g., a router, etc.), that facilitates communication between the door 30 and the network 207. By way of example, the door 30 may be part of a local area network, and an access point may facilitate communication between the local area network and a wide area network (e.g., the Internet). In other embodiments, the door 30 communicates directly with the network 207, and the access point is omitted. By way of example, the network 207 may be a cellular network, and the door 30 may communicate directly with the network 207 (e.g., through a cellular receiver of the communication interface 136).

As shown in FIG. 3, the control system 100 may communicate with one or more user devices (e.g., smartphones, tablets, laptop computers, desktop computers, key fobs, kiosk, a control panel, a hub device, an Internet Of Things (IOT) device, etc.), shown as user devices 190. Each user device 190 may be associated with (e.g., owned by, registered to, etc.) one or more users. A user may utilize the user device 190 to issue commands to the control system 100 and/or review information provided by the control system 100.

Referring still to FIG. 3, the control system 100 may additionally or alternatively include one or more external computing units or remote systems, shown as server(s) 200. The server(s) 200 may be associated with a homeowner, a manufacturer of the door 30, and/or a third party service. The server(s) 200 may store information and/or perform processing to facilitate operation of the door system 10. In some embodiments, the server(s) 200 may refer to or include one or more remote devices that are separate and/or discrete from the controller 130.

One or more of the servers 200 may be designated as third-party servers 209. The third-party servers 209 may be associated with (e.g., operated by) a third party. By way of example, the third party may be a service provider that offers Internet-based hosting services or cloud infrastructure. By way of example, the third-party servers 209 may be operated by Amazon Web Services, Google Cloud, Microsoft Azure, IBM Cloud, Oracle Cloud, or another cloud hosting service.

As shown in FIG. 3, each user device 190 includes a processing circuit, shown as processor 192, operatively coupled to a memory device, shown as memory 194. The memory 194 may store one or more instructions that are executed by the processor 192 to perform the processes described herein. The user device 190 further includes a network interface or communication adapter, shown as communication interface 196. The communication interface 196 is configured to facilitate communication between the user device 190 and the other components of the control system 100 (e.g., through the network 207). The communication interface 196 may be configured to perform wired and/or wireless configuration. By way of example, the communication interface 196 may communicate using near-field communication (NFC), radio-frequency identification (RFID), Bluetooth low energy (BLE), Bluetooth, Wi-Fi, Zigbee, over a cellular network, or through another communication protocol. The communication interface 196 may communicate directly with other devices or over a local area network or a wide area network (e.g., the Internet). The user device 190 includes a user interface 198, which communicates information to a user and/or receives information (e.g., commands) from the user. By way of example, the user interface 198 may include microphones, speakers, touchscreens, buttons, switches, knobs, or other input devices and/or output devices.

As shown in FIG. 3, each server 200 includes a processing circuit, shown as processor 202, operatively coupled to a memory device, shown as memory 204. The memory 204 may store one or more instructions that are executed by the processor 202 to perform the processes described herein. The server 200 further includes a network interface or communication adapter, shown as communication interface 206. The communication interface 206 is configured to facilitate communication between the server 200 and the other components of the control system 100 (e.g., through the network 207). The communication interface 206 may be configured to perform wired and/or wireless configuration. By way of example, the communication interface 206 may communicate using NFC, RFID, BLE, Bluetooth, Wi-Fi, Zigbee, over a cellular network, or through another communication protocol. The communication interface 206 may communicate directly with other devices or over a local area network or a wide area network (e.g., the Internet).

### Voice Passthrough

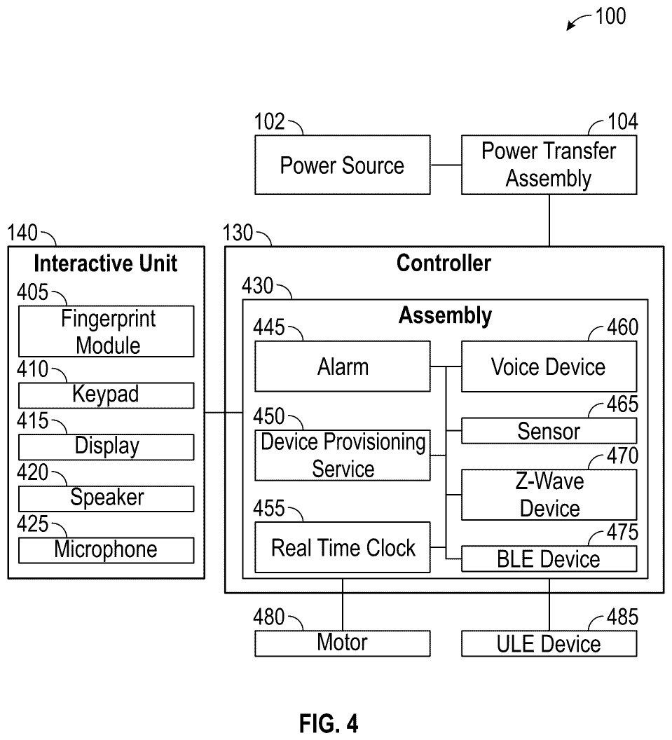

FIG. 4 depicts another block diagram of the control system 100, according to an exemplary embodiment. In some embodiments, the controller 130 includes an assembly 430. The assembly 430 may include at least one of one or more System on Chips (SoC), one or more Printed Circuit Boards (PCBs), one or more microcontrollers, one or more data processors, and/or one or more circuitry components. In some embodiments, the assembly 430 is communicably coupled with one or more devices. For example, as shown in FIG. 4, the assembly 430 is communicably coupled with the interactive unit 140, a motor 480, and an Ultra Low Energy (ULE) device 485. In some embodiments, the assembly 430 transmits one or more signals to various devices. In some embodiments, the assembly 430 includes at least one housing to receive and/or otherwise keep one or more components of the controller 130. For example, the housing of the assembly 430 may define a body for which one or more components may be disposed in.

In some embodiments, the assembly 430 includes or is coupled to the power source 102, the power transfer assembly 104, an alarm 445, a device provisioning service 450, a real time clock 455, a voice device 460, a sensor 465, a Z-wave device 470, and/or a Bluetooth (BLE) device 475. In some embodiments, the interactive unit 140 includes a fingerprint module 405, a keypad 410, a display 415, a speaker 420, and/or a microphone 425. In some embodiments, the processor 132 may execute instructions, stored in memory 134, to control the various components and/or devices of the controller 130. In other embodiments, the processor 132 may execute instructions, stored in memory 134, that cause the processor 132 to perform operations similar to those described herein.

In some embodiments, the controller 130 receives one or more indications. For example, the controller 130 may receive indications associated with one or more trigger events (e.g., a detection of a user proximate to the door 30, a detection of an interaction with the interactive unit 140, a detection of the user device 190 proximate to the door 30, a signal from the server 200 and/or the third-party servers 209, etc.). In some embodiments, the controller 130 receives the indications from one or more devices. For example, the interactive unit 140 may provide one or more signals, to the controller 130, responsive to an interaction with the keypad 410. To continue this example, the controller 130 may receive the indication of a trigger event (e.g., the interaction with the keypad 410) based on the signals provided by the interactive unit 140. As another example, the controller 130 may receive one or more signals from a control panel (e.g., the user device 190) that provides an indication of a trigger event. To continue this example, the trigger event may include the control panel detecting a second user device 190 proximate to the control panel and/or the controller 130. In this example, the control panel may transmit one or more signals to provide an indication of the trigger event to the controller 130.

In some embodiments, the controller 130 may initiate a collection of data. For example, the controller 130 may transmit signals, to the microphone 425, to cause the microphone 425 to collect data (e.g., audio data, audible information, etc.). To continue this example, the controller 130 may store the data in the memory 134 as the microphone 425 continues to collect subsequent data. In some embodiments, the controller 130 may initiate the collection of data responsive to receipt of the indications of the trigger events. For example, the controller 130 may be in a rest and/or sleep mode, prior to the trigger event, and the receipt of the indication of the trigger event may cause the controller 130 to take one or more actions. In some embodiments, the collection of data may refer to and/or include an initiation of one or more actions. For example, the controller 130 may perform one or more actions to initiate the collection of data. As another example, the controller 130 may perform one or more actions prior to and/or subsequent to the collection of data.

In some embodiments, the controller 130 initiates the collection of data based on interactions with the interactive unit 140. For example, the controller 130 may cause the microphone 425 to collect data responsive to a determination that a user has begun speaking. As another example, the controller 130 may initiate the collection of data responsive to a user selecting an icon displayed, via a user interface, by the display 415. In some embodiments, the controller 130 receives one or more trigger events based on a determination that the user has begun to speak. In other embodiments, the controller 130 may receive one or more trigger events based on various determinations and/or detections by the controller 130.

In some embodiments, the controller 130 initiates one or more actions based on the trigger events. For example, the controller 130 may cause the display 415 to provide a visual prompt based on the trigger event including a detection of a user proximate to the door 30. As another example, the controller 130 may cause the keypad 410 to illuminate based on the microphone receiving a request to illuminate the keypad 410.

In some embodiments, the controller 130 provides one or more prompts. For example, the controller 130 may provide a prompt for a user to provide a response. As another example, the controller 130 may provide a prompt to enter a code via the keypad 410. In some embodiments, the controller 130 provides a prompt for a user to provide an audio input (e.g., words, characters, numbers, etc.). For example, the controller 130 may cause the speaker 420 to emit a phrase and/or words asking (e.g., prompting) the user for the audio input. As another example, the controller 130 may provide the prompt responsive to the microphone 425 beginning to collect data (e.g., the microphone 425 begins to collect data and then the user is prompted).

In some embodiments, the controller 130 tracks one or more amounts of time. For example, the controller 130 may track an amount of time subsequent to an initiation of a collection of data (e.g., how long has the collection of data been occurring). As another example, the controller 130 may track an amount of time between trigger events (e.g., how much time elapsed between a first trigger event and a second trigger event). As even another example, the controller 130 may track an amount of time subsequent to providing one or more prompts (e.g., how much time has elapsed since providing the prompt). As another example, the controller 130 may track an amount of time since initiation of the collection of data. In this example, the controller 130 may track how long the response has been recorded for.

In some embodiments, the controller 130 detects that one or more amounts of time have exceeded one or more predetermined thresholds (e.g., an elapsed amount of time is larger than a predetermined threshold). For example, a predetermined threshold may be three seconds and the amount of time may correspond to how long the microphone 425 has been collecting data. To continue this example, the controller 130 may detect, via the real time clock 455, when the amount of time (e.g., how long the microphone 425 has been collecting data) exceeds three seconds. As another example, the data collected by the microphone 425 may be time stamped. To continue this example, the controller 130 may determine, based on one or more time stamps, that the amount of time has exceeded the predetermined thresholds.

In some embodiments, the controller 130 terminates the collection of data. For example, the controller 130 may cause the microphone 425 to halt and/or stop the collection of data. As another example, the controller 130 may cause the speaker 420 to provide an indication that the collection of data (e.g., a recording) has stopped. As another example, the controller 130 may terminate the collection of data responsive to receiving one or more signals from the user device 190. As another example, the controller 130 may terminate the collection of data responsive to a determination that the user has stopped providing audio inputs (e.g., no longer speaking, paused for too long, etc.). In some embodiments, the controller 130 terminates the collection of data based on the amounts of time exceeding the predetermined thresholds. For example, the microphone 425 may collect data for a given amount of time (e.g., a predetermined threshold) and once this given amount of time is elapsed, the controller 130 may cause the microphone 425 to stop collecting data.

In some embodiments, the controller 130 terminates the collection of data based on criteria associated with the trigger event. For example, the trigger event may include a detection of a user speaking to the microphone 425. To continue this example, the controller 130 may terminate the collection of data based on the user have stopped speaking (e.g., criteria). As another example, the trigger event may include the user device 190 transmitting signals to the controller 130 that cause the microphone 425 to record. In this example, the controller 130 may stop the recording based on the user device 190 transmitting a termination signal (e.g., criteria).

In some embodiments, the controller 130 transmits data via one or more signals. For example, the controller 130 may transmit data via signals provided by at least one of the Z-wave device 470, the BLE device 475, and/or the ULE device 485. In some embodiments, the controller 130 transmits data to one or more devices described herein. For example, the controller 130 may transmit data to a hub device (e.g., the user device 190). To continue this example, the hub device may process (e.g., analyze, evaluate, etc.) the data transmitted by the controller 130.

In some embodiments, the controller 130 transmitting data (e.g., voice data) collected by the controller 130 and/or one or more devices thereof and the processing of the data, by a device external to the door, is referred to herein as voice passthrough. For example, (a) the controller 130 transmitting data to the user device 190 (e.g., a hub device, a control panel, etc.), the server 200, and/or the third-party servers 209 and (b) the user device 190, the server 200, and/or the third-party servers 209 processing the data may be considered voice passthrough.

In some embodiments, the controller 130 receives one or more signals. For example, the controller 130 may receive signals from the user device 190. As another example, the controller 130 may receive signals from the server 200. In some embodiments, the controller 130 receives signals that include an indication to perform an action. For example, the controller 130 may receive a signal that includes an instruction to unlock the door 30. As another example, the controller 130 may receive a signal that includes the results of the processing of audio/voice data. To continue this example, the results of the processing of the audio data may include that the audio input provided by the user matches an audio input stored in a database.

In some embodiments, the controller 130 controls one or more devices as a result of the processing of the data. For example, the controller 130 may control the motor 480 to cause the motor 480 to actuate the deadbolt 150 thereby unlocking the door 30. As another example, the controller 130 may cause the speaker 420 to provide an audible feedback to indicate that the door 30 is unlocked.

In some embodiments, the controller 130 provides feedback to indicate a result of the processing of the data collected by the controller 130. For example, the results of the processing of the data may be that the provided audio input did not match a stored audio input. To continue this example, the controller 130 may cause the speaker 420 to provide a message and/or phrase (e.g., an audible feedback) to ask the user to provide a subsequent audio input.

In some embodiments, the controller 130 serves as a gateway and/or a hub between a user providing the audio input and a device (e.g., third-party device, the user device 190, the server 200, the third-party servers 209, etc.) processing the audio input. For example, the controller 130 may simply forward and/or transmit the audio input to the device. As another example, the controller 130 may transmit the data without any modification and/or evaluation. To continue this example, the controller 130 may serve just as a collection device (e.g., the device collecting the audio input) and the controller 130 may then transmit the audio input to an external device for processing by the external device.

While some of the examples described herein have included the controller 130 collecting audio data and/or audio inputs, it should be understood that the controller 130 can collect various types of data and/or information. For example, the controller 130 may collect data to indicate interactions with the keypad 410 (e.g., which buttons, letters, numbers, etc. are selected). As another example, the controller 130 may collect data to indicate interactions with the fingerprint module 405 (e.g., fingerprints, biometrics, retina scan, facial images, etc. provided to the fingerprint module 405).

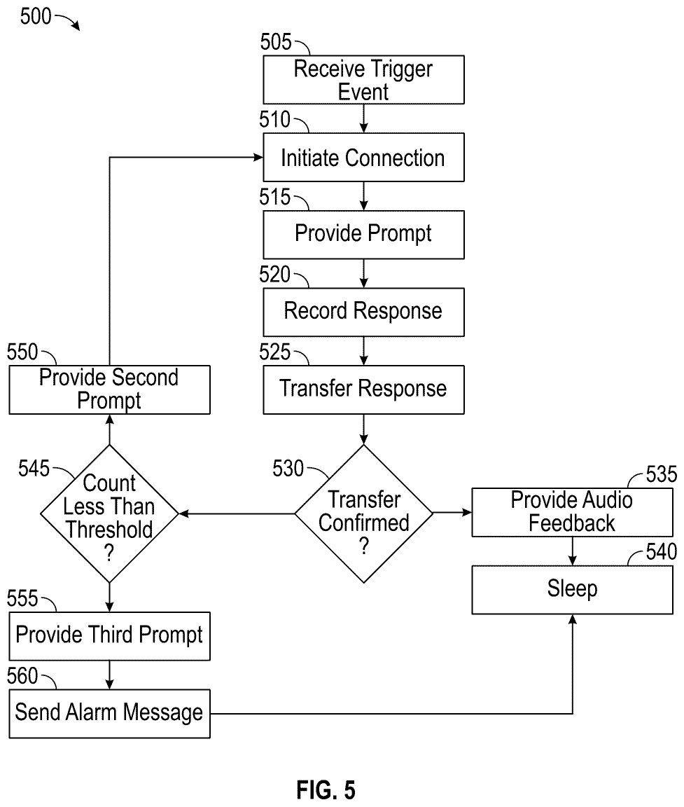

FIG. 5 depicts a flow chart of a process 500 to collect data associated with one or more trigger events, according to an exemplary embodiment. In some embodiments, at least one of the various systems, devices, and/or components described herein may perform at least one of the steps of the process 500. For example, the server 200 may perform at least one of the steps of the process 500. As another example, the processor 132 may perform at least one of the steps of the process 500.

In some embodiments, at step 505, a trigger event is received. For example, the controller 130 may receive a trigger event from the user device 190. As another example, the controller 130 may receive a trigger event based on interactions with the interactive unit 140 (e.g., the fingerprint module 405, the keypad 410, the microphone 425, etc.). In some embodiments, the controller 130 may receive the trigger event responsive to a request to unlock the door 30. For example, the trigger event may include a user requesting to unlock the door 30. To continue this example, the trigger event and/or an indication of the trigger event may be forwarded to the controller 130.

In some embodiments, at step 510, a connection is initiated. For example, the controller 130 may initiate, via the ULE device 485, a connection with a hub device (e.g., the user device 190). As another example, the controller 130 may initiate a connection by causing the microphone 425 to begin collecting data (e.g., record, obtain, and/or capture). In some embodiments, the controller 130 initiates the connection responsive to receiving the trigger event in step 505.

In some embodiments, at step 515, a prompt is provided. For example, the controller 130 may provide a prompt to a user. As another example, the controller 130 may cause the speaker 420 to provide an audible feedback. In some embodiments, the audible feedback may refer to and/or include a phrase and/or words emitted by the speaker 420. For example, the audible feedback may include the speaker 420 emitting a prompt “speak passphrase.” To continue this example, the prompt may provide an indication, to the user, for the user to provide their passphrase (e.g., an audio input).

In some embodiments, at step 520, a response is recorded. For example, the controller 130 may cause the microphone 425 to record and/or collect a response (e.g., an audio input) provided by a user. As another example, the microphone 425 may continue to record for a predetermined amount of time. In some embodiments, the controller 130 records the response responsive to the initiation of the connection in step 510. In other embodiments, the controller 130 records the response responsive to the providing of the prompt in step 515.

In some embodiments, the audio input (e.g., the response recorded in step 520) may refer to or include a recitation of one or more sets of information. For example, the audible input may include a spoken or other possible audible response to one or more prompts. In some embodiments, the audio input includes a recitation of digits (e.g., a PIN, a number combination, etc.), a recitation of words (e.g., phrases, terminology, proper names, etc.), a recitation of a string of characters (e.g., letter combinations, a data string that includes letters, characters, or numbers, etc.), and/or one or more combinations thereof.

In some embodiments, the controller 130 provides one or more types of feedback to indicate that the response is being recorded. For example, the controller 130 may cause one or more Light Emitting Diodes (LEDs) to flash, blink, and/or produce light. As another example, the controller 130 may cause the display 415 to provide a visual indication that the response is being recording (e.g., the display 415 provides a message). As another example, the controller 130 may provide feedback via haptics (e.g., vibrations, pulses, etc.). As even another example, the controller 130 may provide feedback by causing the speaker 420 to emit a beep or other discernable noise.

In some embodiments, at step 525, the response is transferred. For example, the controller 130 may transfer the response recorded in step 520 to one or more devices. In some embodiments, the controller 130 may transfer the response to a third-party or external device (e.g., the user device 190, the server 200, the third-party servers 209, etc.). For example, the controller 130 may transfer the response to a hub device for processing of the response by the hub device. As another example, the controller 130 may transfer, via the ULE device 485, the response to the hub device.

In some embodiments, at step 530, a confirmation of the transfer is made. For example, the controller 130 may determine that the hub device received the response, transferred in step 525, based on receiving a confirmation message from the hub device. As another example, the controller 130 may determine that the hub device did not receive the response based on an inability to connect with the hub device. In some embodiments, the process 500 proceeds to step 535 based on confirmation of the transfer. In some embodiments, the process 500 proceeds to step 545 based on determining that the transfer was not confirmed.

In some embodiments, at step 535, audio feedback is provided. For example, the controller 130 may cause the speaker 420 to provide and/or emit a message (e.g., an audio feedback). In some embodiments, the speaker 420 provides a message to indicate the transfer of the recording. For example, the speaker 420 may emit a message “checking passphrase.” As another example, the display 415 may provide a visual indication of the message provided by the speaker 420. In some embodiments, the process 500 proceeds to step 540 responsive to providing the audio feedback.

In some embodiments, at step 545, a determination if a count is less than a threshold is made. For example, the controller 130 may determine a number of times attempted, in step 525 and/or step 530, to transfer the response recorded in step 520. As another example, the controller 130 may update a count responsive to a determination, in step 530, that the transfer was not confirmed. In some embodiments, the process 500 proceeds to step 550 responsive to a determination that the count is less than the threshold. In other embodiments, the process 500 proceeds to step 555 responsive to a determination that the count is greater than and/or equal to the threshold.

In some embodiments, at step 550, a second prompt is provided. For example, the controller 130 may cause the display 415 to display a message. As another example, the controller 130 may cause the speaker 420 to provide audible feedback (e.g., a message, a sound, etc.). In some embodiments, the controller 130 causes the speaker 420 to repeat the prompt provided in step 515. In other embodiments, the controller 130 causes the speaker 420 to provide a different prompt. For example, the controller 130 may cause the speaker 420 to emit a message “please say again.”). In some embodiments, the process 500 proceeds to step 510 responsive to providing the second prompt.

In some embodiments, at step 555, a third prompt is provided. For example, the speaker 420 may emit a message to indicate that the count (e.g., attempts) exceeded the threshold. In some embodiments, the speaker 420 emits a message to indicate one or more subsequent actions for the user. For example, the speaker 420 may emit a message “use other access method,” to indicate to the user to attempt a different access method.

In some embodiments, at step 560, an alarm message is sent. For example, the controller 130 may send, via the z-wave device 470, a message to the hub device to indicate that the user was prompted to perform a different access method. To continue this example, the message may also include an indication as to which access methods were identified to the user.

In some embodiments, at step 540, a sleep protocol is initiated. For example, the controller 130 and/or one or more devices thereof may enter an idle and/or rest mode. In some embodiments, the sleep protocol refers to and/or includes the controller 130 decreasing and/or adjusting an amount of power consumed by the controller 130 and one or more devices thereof. In some embodiments, the receipt of one or more trigger events (e.g., step 505), causes the controller 130 to exit and/or leave the sleep protocol.

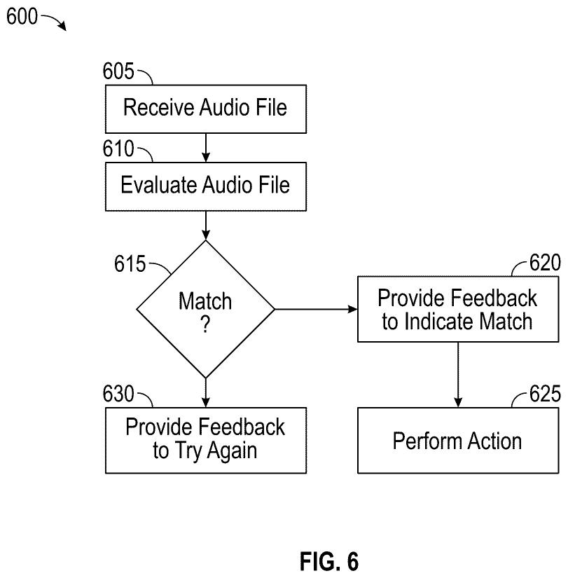

FIG. 6 depicts flow chart of a process 600 to evaluate data collected as a result of one or more trigger events, according to an exemplary embodiment. In some embodiments, at least one of the various systems, devices, and/or components described herein may perform at least one of the steps of the process 600. For example, the server 200 may perform at least one of the steps of the process 600. As another example, the processor 132 may perform at least one of the steps of the process 600. Accordingly, the process 600 may be performed remotely (e.g., by a server 200 remote from the door 30, by the user device 190, by the third-party servers 209, etc.) and/or locally (e.g., by the controller 130 of the door 30). In embodiments where the process 600 is performed locally, the steps of transferring one or more audio files may be omitted.

In some embodiments, at step 605, an audio file is received. For example, the user device 190 and/or the server 200 (e.g., a hub device, a control panel, a third-party device, etc.) may receive the response transferred in step 525. As another example, the user device 190 and/or the server 200 may receive data collected by the microphone 425 (e.g., an audio input, an audio file, a recording, etc.).

In some embodiments, at step 610, the audio file is evaluated. For example, the user device 190 and/or the server 200 may evaluate the audio file received in step 605. In some embodiments, the user device 190 and/or the server 200 may evaluate the audio file by comparing the audio file with a stored version of the audio file. For example, a database may store various audio files (e.g., stored versions) and the user device 190 and/or the server 200 may retrieve and/or utilize the stored versions to compare with audio files provided by the controller 130. In some embodiments, the user device 190 and/or the server 200 converts or otherwise analyzes the audio file to extract a feature or characteristic. By way of example, the user device 190 and/or the server 200 may perform a frequency analysis on the audio file (e.g., to identify which frequencies are most prevalent). The user device 190 and/or the server 200 may compare the frequency analysis to analysis results stored in the database (e.g., based on speech samples provided by an authorized user). The user device 190 and/or the server 200 may accordingly see if speech patterns in the audio file match speech patterns of an authorized user. By way of another example, the user device 190 and/or the server 200 may analyze the audio file and identify or extract spoken words contained in the audio file (e.g., a spoken phrase or series of numbers and/or letters). The user device 190 and/or the server 200 may compare the extracted words to predetermined codes or passphrases (e.g., stored as text) in the database to see if a spoken words match an accepted code or passphrase.

In some embodiments, at step 615, a determination of a match is made. For example, the user device 190 and/or the server 200 may determine that the audio file, received in step 605, matches a version stored in the database (e.g., an authenticate response, a verified response, etc.). As another example, the user device 190 and/or the server 200 may determine the match responsive to comparing the audio file with the stored version in step 610. In some embodiments, the process 600 proceeds to step 620 responsive to a determination that there is a match. In other embodiments, the process 600 proceeds to step 630 responsive to a determination that there is not a match.

In some embodiments, at step 620, feedback to indicate the match may be provided (e.g., step 535). For example, the user device 190 and/or the server 200 may transmit a signal to the controller 130 that cause the speaker 420 to emit a message (e.g., feedback) that indicates a match. As another example, the user device 190 may emit and/or provide the message. In some embodiments, the feedback to indicate the match may include emitting a message “passphrase match.” For example, the feedback may indicate that the response received in step 520 matched a stored version.

In some embodiments, at step 625, an action is performed. For example, the user device 190 and/or the server 200 may transmit a signal to the z-wave device 470 to cause the controller 130 to control the motor 480. Stated otherwise, the user device 190 and/or the server 200 may transmit a signal to cause the controller 130 to unlock the door 30. As another example, the user device 190 and/or the server 200 may transmit a signal to cause the display 415 to display a message to indicate the unlocking of the door 30. As another example, the user device 190 and/or the server 200 may be associated with and/or monitored by a security system and/or security service. To continue this example, the action may include notifying and/or corresponding with police services, medical services, and/or fire services. As another example, the user device 190 and/or the server 200 may forward and/or transmit the audio file to police services, medical services, and/or fire services. To continue this example, the audio file may identify and/or indicate a status and/or condition. In this example, transmitting the audio file may assist the authorities in understand the situation.

In some embodiments, at step 630, feedback to try again is provided (e.g., step 535). For example, the user device 190 and/or the server 200 may transmit a signal to the z-wave device 470 to cause the speaker 420 to emit a message “no match, try again.” As another example, the user device 190 and/or the server 200 may transmit a signal to the controller to cause the speaker 420 to emit an error message. As even another example, the user device 190 and/or the server 200 may transmit a signal to the controller 130 to cause the display 415 to provide a visual indication of the message. In some embodiments, the user device 190 and/or the server 200 providing the feedback to try again may cause the controller 130 to repeat, reproduce, and/or replicate step 510 of the process 500.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the door system 10 and as shown in the various exemplary embodiments are illustrative only. Additionally, any element disclosed in one embodiment may be incorporated or utilized with any other embodiment disclosed herein.

1. A door system configured to be integrated with or coupled to a door, the door system comprising:
a controller configured to communicate with a motor to control a lock for the door, the controller configured to:
receive an indication of a trigger event associated with the door;
responsive to receipt of the indication of the trigger event, initiate control of an audio device to collect a first dataset;
provide, via the audio device, responsive to initiation of control of the audio device, a prompt to provide an audio input;
terminate collection of the first dataset based on criteria associated with the audio input or the trigger event; and
transmit the first dataset to an external device for processing by the external device.

2. The door system of claim 1, wherein the controller is configured to:
receive, from the external device, one or more signals that include an indication to unlock the door; and
cause, responsive to receipt of the one or more signals, the motor to control the lock for the door to unlock the door.

3. The door system of claim 1, wherein the controller is configured to provide, responsive to receipt of one or more signals from the external device, an audible feedback to indicate a result of the processing by the external device.

4. The door system of claim 1, wherein the controller is configured to transmit the first dataset to the external device without any modification or evaluation of the first dataset by the controller.

5. The door system of claim 1, wherein the first dataset is transmitted via Ultra Low Energy (ULE) specifications.

6. The door system of claim 1, wherein the controller is configured to:
control one or more light emitting diodes (LEDs) to provide a visual output to indicate initiation of the collection of the first dataset; and
terminate, responsive to an amount of time exceeding a predetermined threshold, the visual output to indicate an end to the collection of the first dataset.

7. The door system of claim 1, wherein the audio input includes at least one of a recitation of one or more digits, a recitation of one or more words, a recitation of a string of characters, or a recitation of a combination of the one or more digits, the one or more words, or the string of characters.

8. The door system of claim 1, wherein the external device includes a third-party device supported by a third-party service.

9. The door system of claim 1, further comprising the audio device, wherein the audio device and the controller are disposed within a common housing.

10. The door system of claim 1, further comprising one or more non-transitory computer-readable storage media storing instructions thereon that, when executed by one or more processors of the external device, cause the one or more processors of the external device to:
provide, to the controller, the indication of the trigger event;
receive, from the controller, the first dataset;
retrieve, from a database, information associated with the door;
evaluate, responsive to retrieval of the information, the first dataset based on the information associated with the door;
detect, responsive to evaluation of the first dataset, a match between at least a portion of the first dataset and at least a portion of the information; and
transmit, responsive to detection of the match, one or more signals, to the controller, to provide an indication to unlock the door.

11. A door lock system comprising:
a lock including a motor, the lock configured to couple to a door;
a controller in communication with the motor to control the lock, the controller configured to:
receive an indication of a trigger event associated with the door;
initiate control of a microphone to collect an audio input; and
transmit the audio input to an external device for processing by the external device.

12. The door lock system of claim 11, wherein the controller is configured to:
receive, from the external device, one or more signals that include an indication to unlock the door; and
cause, responsive to receipt of the one or more signals, the motor to control the lock to unlock the door.

13. The door lock system of claim 11, wherein the controller is configured to provide, via at least one of a speaker or a display, responsive to initiation of control of the microphone, a prompt for a user to provide the audio input.

14. The door lock system of claim 11, wherein the controller is configured to provide, responsive to receipt of one or more signals from the external device, feedback via at least one of a speaker or a display to indicate a result of the processing by the external device.

15. The door lock system of claim 11, wherein the controller is configured to transmit the audio input to the external device without any modification or evaluation of the audio input by the controller.

16. The door lock system of claim 11, wherein the audio input is transmitted via Ultra Low Energy (ULE) specifications.

17. The door lock system of claim 11, wherein the controller is configured to:
control one or more visual devices to provide a visual output to indicate initiation of the collection of the audio input; and
terminate, responsive to an amount of time exceeding a predetermined threshold, the visual output to indicate an end to the collection of the audio input.

18. The door lock system of claim 11, wherein the audio input includes at least one of a recitation of one or more digits, a recitation of one or more words, a recitation of a string of characters, or a recitation of a combination of the one or more digits, the one or more words, or the string of characters.

19. A system comprising:
one or more non-transitory computer-readable storage media storing instructions thereon that, when executed by one or more processors, cause the one or more processors to:
provide, to a controller via one or more signals, responsive to detection of a trigger event associated with a door, an indication of the trigger event;
receive, from the controller via one or more second signals, data collected by the controller as a result of the trigger event;
retrieve, from a database, information associated with the door;
evaluate, responsive to retrieval of the information, the data collected by the controller based on the information associated with the door;
detect, responsive to evaluation of the data, a match between at least a portion of the data collected by the controller and at least a portion of the information; and
transmit, responsive to detection of the match, one or more third signals, to the controller, to provide an indication of to unlock the door.

20. The system of claim 19, wherein the instructions further cause the one or more processors to:
receive, from the controller, the data without modification or evaluation by the controller; and
execute, responsive to receipt of the data, a multi-factor authentication protocol using the data and one or more sets of information stored in the database.
